(19) United States
(12) Patent Application Publication
(10) Pub. No.: US 2011/0283302 A1
(43) Pub. Date: Nov. 17, 2011

(54) Disk chucking device and motor device having the same

(75) Inventors: Yeol Choi, Gwangmyeong (KR); Young Sun Yoo, Suwon (KR); Ho Jun Yoo, Suwon (KR)

(73) Assignee: SAMSUNG ELECTRO-MECHANICS CO., LTD., Suwon (KR)

(21) Appl. No.: 13/064,621

(22) Filed: Apr. 4, 2011

(30) Foreign Application Priority Data
May 11, 2010 (KR) 10-2010-0044175

(51) Int. Cl. G11B 17/028

(52) U.S. Cl. 720/715; G9B/17.006

(57) ABSTRACT

Disclosed is a disk chucking device. A disk chucking device according to an aspect of the invention may include: a chuck housing mounted on one surface of a rotor case being rotatable and having a receiving portion with an outside opening to be connected to a receiving space provided therein; and a chuck chip comprising an elastic plate being elastically transformed when a disc being mounted on the rotor case is inserted and securing an inter circumferential surface of the disc.

### CROSS-REFERENCE TO RELATED APPLICATIONS

This application claims the priority of Korean Patent Application No. 10-2010-0044175 filed on May 11, 2010, in the Korean Intellectual Property Office, the disclosure of which is incorporated herein by reference.

### BACKGROUND OF THE INVENTION

1. Field of the Invention

The present invention relates to a disk chucking device and a motor device having the same, and more particularly, to a disk chucking device that stably mounts a disc at a mounting position and a motor device having the same.

2. Description of the Related Art

In general, a spindle motor, which is installed inside an optical disc drive, rotates a disc so that an optical pickup can read data recorded on the disc.

There has been a demand for small, lightweight, and thin optical disc drivers. In particular, as for ultra-thin, slim motors, being used in laptop computers, magnetic circuits for driving these motors have also been reduced in size. Thus, various designs thereof have been developed in order to generate torque high enough to rotate optical discs and ensure the stable rotation of the optical discs.

A motor may include a separate disk chucking device in order to stably mount a disc.

In the related art, a disk chucking device according to this embodiment includes a chuck housing, a spring, and a chuck member. The chuck housing has an opening in which the chuck member for securing a disc is assembled. The spring is mounted inside the chuck housing. The chuck member is elastically moved into the chuck housing by the spring.

However, it is difficult to precisely assemble a disk chucking device since the components thereof including the spring and the chuck member are small. When the disk chucking device is not precisely assembled, the spring and the chuck member are not disposed in accurate positions, and thus the chuck member ends up being inserted into the chuck housing and fails to return to its original position. Therefore, there is a need for techniques to solve these problems.

### SUMMARY OF THE INVENTION

An aspect of the present invention provides a disk chucking device that is easily assembled on a chuck housing and is capable of reducing the number of components therein, and a motor device having the same.

According to an aspect of the present invention, there is provided a disk chucking device including: a chuck housing mounted on one surface of a rotor case being rotatable and having a receiving portion with an outside opening to be connected to a receiving space provided therein; and a chuck chip comprising an elastic plate being elastically transformed when a disc being mounted on the rotor case is inserted and securing an inter circumferential surface of the disc.

The chuck chip may protrude outward from the receiving portion.

The elastic plate may be bent such that one end thereof comes into contact with an inner surface and an upper surface of the receiving portion at the same time.

A receiving recess may be provided in the chuck housing so that one end of the elastic plate is inserted into the receiving recess.

Receiving recesses may be provided in the chuck housing so that both ends of the elastic plate are inserted into the receiving recesses.

a elastic plate has a protruding portion outward from the receiving portion, and wherein the protruding portion comprises an insertion portion being obliquely bent in order to insert the disc and a mounting portion being obliquely bent in an opposite direction to the insertion portion in order to mount the disc being inserted. The mounting portion may be bent to have a curved cross-section.

The disk chucking device may further include a buffer material being bonded to an inner surface of the elastic plate.

According to another aspect of the present invention, there is provided a motor device including: a sleeve having a shaft hole therein; a shaft inserted into the shaft hole; a rotor case mounted on the shaft so as to be rotatable; a chuck housing mounted on one surface of the rotor case and including a receiving portion with an outside opening to be connected to a receiving space provided therein; and a chuck chip comprising an elastic plate being elastically transformed when a disc being mounted on the rotor case is inserted and securing an inner circumferential surface of the disc.

The elastic plate may be bent such that one end thereof comes into contact with an inner surface and an upper surface of the receiving portion at the same time.

A receiving recess may be provided in the chuck housing such that one end of the elastic plate is inserted into the receiving recess.

Receiving recesses may be provided in the chuck housing such that both ends of the elastic plate are inserted into the receiving recesses.

the elastic plate has a protruding portion outward from the receiving portion, and wherein the protruding portion may include an insertion portion being obliquely bent in order to insert the disc and a mounting portion being bent obliquely in an opposite direction to the insertion portion in order to mount the disc being inserted.

The mounting portion may be bent to have a curved cross-section.

The motor device may further include a buffer material being bonded to an inner surface of the elastic plate.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a partially cut-away perspective view illustrating a disk chucking device and a motor device according to an exemplary embodiment of the present invention;

FIG. 2 is a cross-sectional view illustrating a disk chucking device and a motor device according to an exemplary embodiment of the present invention;

FIG. 3 is a partial perspective view illustrating an elastic plate of a disk chucking device according to an exemplary embodiment of the present invention;

FIGS. 4 and 5 are cross-sectional views illustrating how a disc is mounted on a motor device according to an exemplary embodiment of the present invention;

FIG. 6 is a cross-sectional view illustrating a disk chucking device of a motor device according to another exemplary embodiment of the present invention;

FIG. 7 is a cross-sectional view illustrating a disk chucking device of a motor device according to another exemplary embodiment of the present invention; and

FIG. 8 is a cross-sectional view illustrating a disk chucking device of a motor device according to another exemplary embodiment of the present invention.

### DETAILED DESCRIPTION OF THE PREFERRED EMBODIMENT

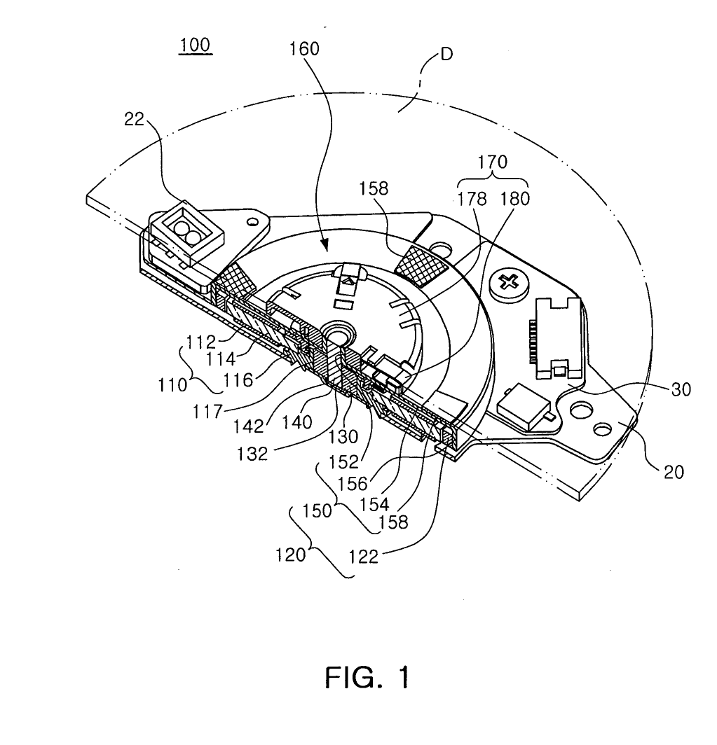

A disk chucking device and a motor device according to exemplary embodiments of the invention will be described in more detail with reference to FIGS. 1 through 8. Exemplary embodiments of the present invention will now be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the same reference numerals will be used throughout to designate the same or like components having the same function.

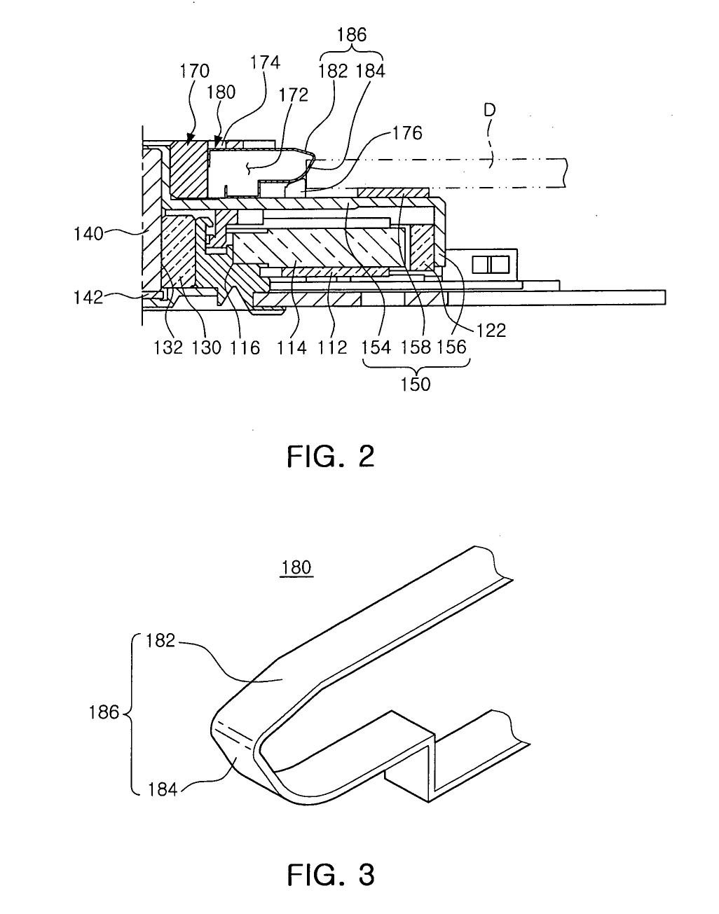

FIG. 1 is a partially cut-away perspective view illustrating a disk chucking device and a motor device according to an exemplary embodiment of the invention. FIG. 2 is a cross-sectional view illustrating a disk chucking device and a motor device according to an exemplary embodiment of the invention.

Referring to FIGS. 1 and 2, a motor device 100 may include a sleeve 130, a shaft 140, a rotor case 150, and a disk chucking device 160.

As shown in FIG. 1, the sleeve 130 may be assembled in such a manner that a lower body of the sleeve 130 is pressed and inserted into a receiving hole 117 of the base 116. Here, the sleeve 130 may refer to a rotation support member that corresponds to the rotor 120 at a predetermined interval therebetween to create a sliding surface therebetween.

A shaft hole 132 may be formed in the sleeve 130 so that the shaft 140 is bound to the sleeve 130 via the shaft hole 132. A plurality of radial dynamic pressure recesses may be formed in an inner surface of the shaft hole 132.

As the shaft 140 may be inserted into the shaft hole 132 of the sleeve 130, the shaft 140 may rotate together with the rotor case 150. The rotor case 150 may be mounted on an upper surface of the shaft 140.

Here, the shaft 140 may extend in the direction of the axis of rotation, and a thrust plate 142 is formed on a lower surface of the shaft 140 to thereby reduce a frictional force relative to the shaft 140 during rotation.

The rotor case 150 may include a hub 152, a horizontal portion 154, and a vertical portion 156. The hub 152 comes into contact with and extends along the side of the shaft 150 from the inlet thereof. The horizontal portion 154 is formed integrally with the hub 152 while a disc D is mounted on the horizontal portion 154. The vertical portion 156 is bent perpendicularly downward from the horizontal portion 154.

Here, since the horizontal portion 154, forming an upper surface of the rotor case 150, may be horizontal, the disc D can be prevented from leaning to one side when the disc D is mounted. A buffer unit 158 may be formed on the horizontal portion 154 such that the buffer unit 158 comes into contact with a lower surface of the disc D. The buffer portion 158 may be formed of rubber.

Therefore, the motor device according to this embodiment includes the rotor case 150 that is engaged with the shaft 140, rotates together with the shaft 140, and supports a disc being disposed on the upper part thereof. Thus, as compared with a structure having a holder assembled on a shaft and a case mounted on the holder, in the case of the motor device according to this embodiment, a further reduction in the thickness thereof can be achieved.

Here, the disk chucking device 160 may include a chuck housing 170 and a chuck chip including an elastic plate 180.

The chuck housing 170 is mounted on the upper part of the rotor case 150 and may include a receiving portion 172 providing a receiving space in which the elastic plate 180 is received while being exposed. Therefore, the receiving portion 172 has an opening therein such that part of the elastic plate 180 may be received therein and exposed to the outside.

Furthermore, a check hole 174 may be formed in an outer surface of the chuck housing 170 in order to check whether the elastic plate 180 is assembled at the right position.

A mounting protrusion 176 is formed in the opening of the chuck housing 170 and protrudes upwards. Here, the surface of the mounting protrusion 176 may be inclined such that the surface in an outer circumferential direction thereof is lower than the surface in an inner direction thereof. Further, the mounting protrusion 176 may be formed integrally with the chuck housing 170.

The chuck housing 170 may include protrusions 178 used to mount the disc D. The protrusions 178 may be formed integrally with the chuck housing 170 and consist of three protrusions spaced 120 degrees apart.

Also, the protrusions 178 may protrude outwardly by a predetermined length and move into the chuck housing 170 when the disc D is inserted. Therefore, for this structure, both sides of each of the protrusions 178 are cut off from the chuck housing 170 so that the protrusions 178 of the chuck housing 170 are spaced apart from each other.

The chuck chip is formed of the elastic plate 180 and comes into contact with an inner circumferential surface of the disc D to thereby fix the position of the disc D.

The elastic plate 180 is inserted into the receiving portion 172 of the chuck housing 170 so that one end of the elastic plate 180 is fixed. Further, portions of the elastic plate 180 protrude outwardly. Here, the mounting protrusions 176 of the chuck housing 170 are disposed on the lower surfaces of protruding portions 186.

Here, the elastic plate 180 may be formed of a sheet material and be shaped to provide an elastic force.

One end of the elastic plate 180 is bent so as to contact inner and upper surfaces of the chuck housing 170 at the same time. Therefore, the elastic plate 180 having this configuration is not shaken by the disc D being mounted, and the position of the end portion of the elastic plate 180 can be fixed. Here, the end portion of the elastic plate 180 may be fixed by an adhesive.

FIG. 3 is a partial perspective view illustrating an elastic plate of a disk chucking device according to an exemplary embodiment of the invention.

Referring to FIG. 3, the elastic plate 180 may include an insertion portion 182 and a mounting portion 184. The insertion portion 182 is formed by bending the protruding portions 186 such that the disc D can be inserted. The mounting portion 148 is formed by bending the protruding portions 186 in an opposite direction to the insertion portion 128 such that the disc D being inserted may be mounted.

Therefore, the disc D comes into contact with the insertion portion 182 and slidingly moves downward. After the disc D is mounted, the disc D comes into contact with the mounting portion 184 and is fixed.

However, in this embodiment, the mounting portion 184 has a curved cross section in an opposite direction to the insertion portion 182. However, the present invention is not limited thereto. According to the designers' intentions, the mounting portion 184 may have a linear cross section.

The disk chucking device disposes the chip member in an internal space of the chuck housing and disposes a spring in the internal space of the chuck housing such that the chip member is elastically moved and the spring comes into contact with the chip member.

An assembly process of the disk chucking device, manufactured in this manner, is not easy to perform since the spring and the chip member are small-sized. When the assembly process is not performed at accurate assembly positions, the chip member may be inserted into the chuck housing and fail to return to its original position or the spring may be transformed.

However, the disk chucking device and the motor device according to this embodiment provide the elastic plate 180 that is inserted into the receiving portion 172 of the chuck housing 170 and protrudes outwards from the receiving portion 172. The disc D being mounted is stably fixed to a predetermined position.

Furthermore, since only the elastic plate 180 is assembled on the chuck housing 170, a precise assembly process is not required as in the existing process of assembling the spring and the chuck member at the same time. Also, since the number of components can be reduced to thereby reduce manufacturing costs.

The configuration, as illustrated in FIGS. 1 and 2, will now be described in detail.

The stator 110 is a stationary part that includes winding coils 112 and cores 114. The winding coils 112 generate an electromagnetic force having a predetermined magnitude when power is applied. The winding coils 112 are wound around the plurality of cores 114 in a radial manner on the basis of at least one pole.

The rotor 120 is a rotating part that is rotatable relative to the stator 110 and includes the rotor case 150, shaped like a cup, which has a magnet 122 having a ring shape along an outer circumferential surface thereof and corresponding to the core 114 by a predetermined interval therebetween. Here, the magnet 122 is a permanent magnet having magnetic north and south poles magnetized alternately in the circumferential direction to thereby generate a magnetic force having a predetermined magnitude.

A base plate 20 is a support against which the motor 100 is supported. A flexible printed circuit board 30 is provided on the base plate 20. The use of the flexible printed circuit board 30 can reduce the thickness of the motor 100 as compared with the case in which a printed circuit board is used.

Here, a plurality of passive devices may be mounted on the base plate 20. In particular, a data reception unit 22 may be prepared in order to receive data when the disc D is rotated.

Circuit patterns may be formed on the flexible printed circuit board 30 in order to apply power to the motor 100. Ground patterns of the flexible printed circuit board 30 may be electrically connected to the base plate 20.

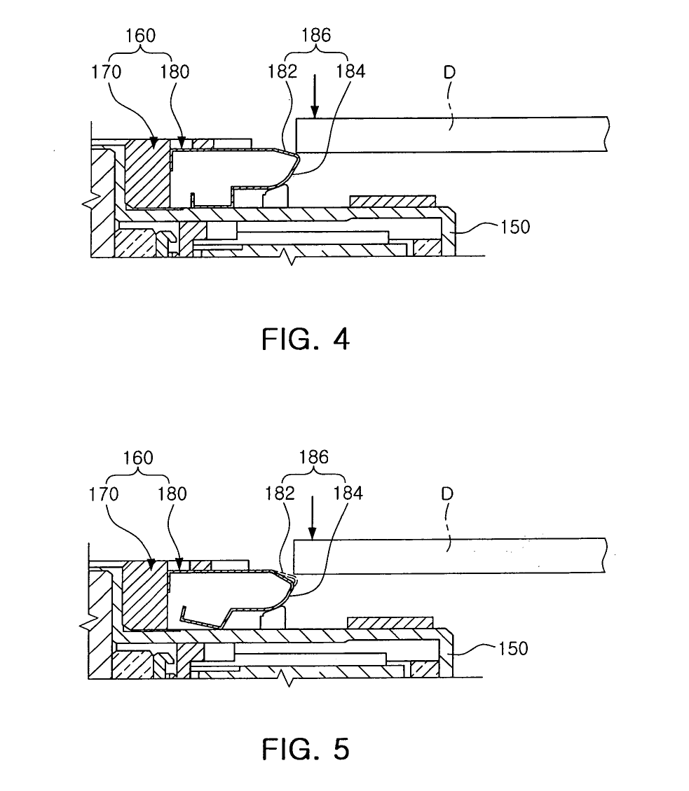

FIGS. 4 and 5 are cross-sectional views illustrating a state in which a disc is mounted on a motor device according to an exemplary embodiment of the invention.

Referring to FIGS. 4 and 5, a disc D having a hollow larger than the disk chucking device 160 is disposed on the rotor case 150 and moves downward.

Here, the disc D comes into contact with the insertion portion 182 of the elastic plate 180, mounted on the chuck housing 170, and slidingly moves downward. The elastic plate 180 in contact with the disc D is transformed such that the elastic plate 180 may move downward.

After the disc D is disposed on the upper surface of the rotor case 150, the elastic plate 180 returns to its original shape and comes into contact with the mounting portion 184 of the elastic plate 180.

Therefore, the motor device according to this embodiment causes the elastic plate 180 to stably fix the position of the disc D being mounted.

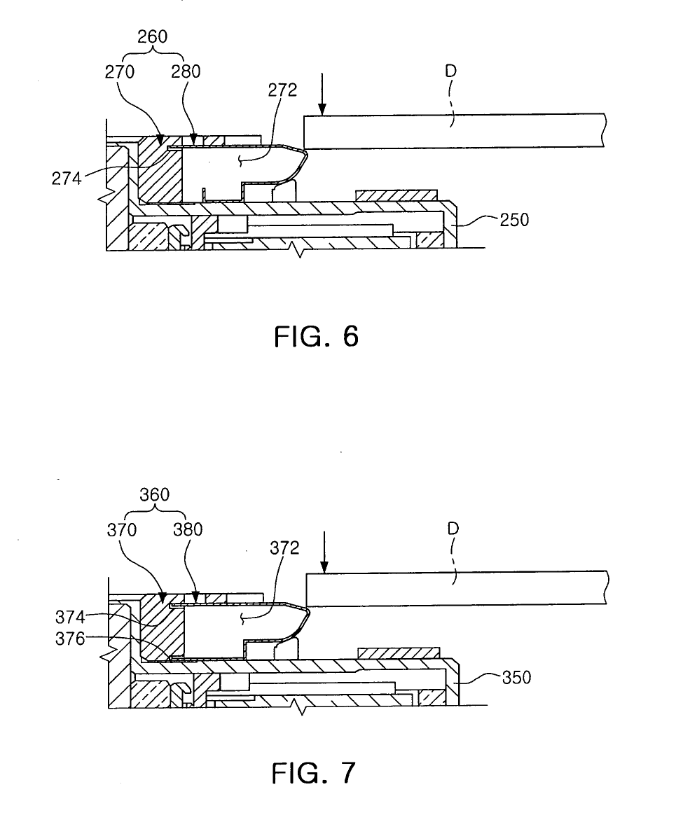

FIG. 6 is a cross-sectional view illustrating a disk chucking device of a motor device according to another exemplary embodiment of the invention.

Referring to FIG. 6, a disk chucking device 260 may include a chuck housing 270 and an elastic plate 280.

In this embodiment, the chuck housing 270 and the motor device have substantially the same configurations as those of the above-described embodiment. Thus, a detailed description thereof will be omitted.

Here, the elastic plate 280 is received in the receiving portion 272 of the chuck housing 270 and partially protrudes outward.

Here, a receiving recess 274 is formed in an inner surface of the receiving portion 272 of the chuck housing 270 such that an end portion of the elastic plate 280 is mounted in the receiving recess 274. Here, the receiving recess 274 has a shape corresponding to the end portion of the elastic plate 280.

Furthermore, the other end of the elastic plate 280 is located on the upper surface of the rotor case 150. A configuration in which the disc D is mounted and fixed by the elastic plate 280 is substantially the same as that of the above-described embodiment.

Therefore, since one end portion of the elastic plate 280 is inserted and fixed into the receiving recess 274 of the chuck housing 270, the elastic plate 280 can be more stably fixed to the position even when external power is applied by the disc D.

FIG. 7 is a cross-sectional view illustrating a disk chucking device of a motor device according to another exemplary embodiment of the invention.

Referring to FIG. 7, a disk chucking device 360 may include a chuck housing 370 and an elastic plate 380.

In this embodiment, the chuck housing 370 and the motor device are substantially the same as those of the above-described embodiment. Thus, a detailed description thereof will be omitted.

Here, the elastic plate 380 is received inside the receiving portion 372 of the chuck housing 370 and partially protrudes outward.

Here, a first receiving recess 374 and a second receiving recess 376 may be formed in an inner surface of the receiving portion 372 of the chuck housing 370 such that one end portion of the elastic plate 380 may be mounted in the first receiving recess 374 and the other end portion thereof may be mounted in the second receiving recess 376.

Here, the first receiving recess 374 and the second receiving recess 376 may be located at positions varying according to the shape of the elastic plate 380. The second receiving recess 376 may also be formed in a rotor case 350.

Therefore, both end portions of the elastic plate 380 are inserted and fixed into the first and second receiving recesses 374 and 376 of the chuck housing 370. Even when external power is applied by the disc D, the elastic plate 380 can be more stably fixed to the position.

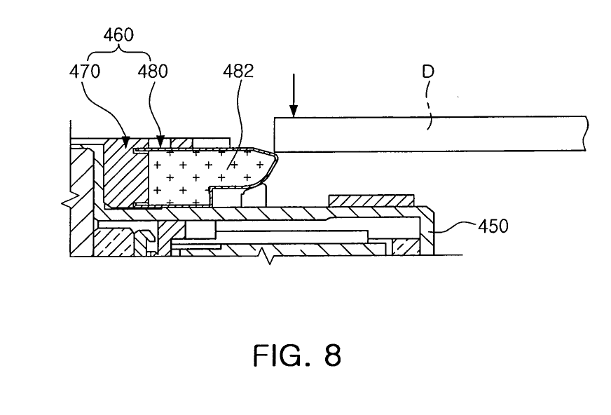

FIG. 8 is a cross-sectional view illustrating a disk chucking device of a motor device according to another exemplary embodiment of the invention.

Referring to FIG. 8, a disk chucking device 460 may include a chuck housing 470 and an elastic plate 480.

In this embodiment, the chuck housing 470 and the motor device have the same configuration as those of the above-described embodiment. A detailed description thereof will be omitted.

Here, the elastic plate 480 is received in an internal space of the chuck housing 470 and partially protrudes outward through an opening.

Here, a buffer material 482 may be bonded to the inside of the elastic plate 480 while the buffer material 482 corresponds to an inner side of the elastic plate 480. Like the above-described embodiment, in this embodiment, end portions of the elastic plate 480 are inserted and fixed into recesses to be formed in the chuck housing. However, the present invention is not limited thereto. The elastic plate 480 may be received in the internal space of the chuck housing 470.

Therefore, in this embodiment, since the buffer material 482 is used to maintain the shape of the elastic plate 480, even when the disc D is pressed hard towards the rotor case 450 by an external force, the elastic plate 480 is barely transformed, and thus it is possible to stably maintain the structure of the disk chucking device.

As set forth above, according to exemplary embodiments of the invention, as a disk chucking device and a motor device include an elastic plate, which is inserted into a receiving portion of a chuck housing and protrudes outward from the receiving portion, a disc being mounted can be stably fixed to a mounting position by a protruding portion of the elastic plate.

Furthermore, since only the elastic plate is assembled on the chuck housing without performing a precise assembly process of assembling a spring and a chuck member at the same time, assembly is facilitated, and the number of components can be reduced to thereby reduce manufacturing costs.

While the present invention has been shown and described in connection with the exemplary embodiments, it will be apparent to those skilled in the art that modifications and variations can be made without departing from the spirit and scope of the invention as defined by the appended claims.

What is claimed is:

1. A disk chucking device comprising:
a chuck housing mounted on one surface of a rotor case being rotatable and having a receiving portion with an outside opening to be connected to a receiving space provided therein; and
a chuck chip comprising an elastic plate being elastically transformed when a disc being mounted on the rotor case is inserted and securing an inter circumferential surface of the disc.

2. The disk chucking device of claim 1, wherein the chuck chip protrudes outward from the receiving portion.

3. The disk chucking device of claim 1, wherein the elastic plate is bent such that one end thereof comes into contact with an inner surface and an upper surface of the receiving portion at the same time.

4. The disk chucking device of claim 1, wherein a receiving recess is provided in the chuck housing so that one end of the elastic plate is inserted into the receiving recess.

5. The disk chucking device of claim 1, wherein receiving recesses are provided in the chuck housing so that both ends of the elastic plate are inserted into the receiving recesses.

6. The disk chucking device of claim 1, wherein the elastic plate has a protruding portion outward from the receiving portion, and wherein the protruding portion comprises an insertion portion being obliquely bent in order to insert the disc and a mounting portion being obliquely bent in an opposite direction to the insertion portion in order to mount the disc being inserted.

7. The disk chucking device of claim 6, wherein the mounting portion is bent to have a curved cross-section.

8. The disk chucking device of claim 1, further comprising a buffer material being bonded to an inner surface of the elastic plate.

9. A motor device comprising:
a sleeve having a shaft hole therein;
a shaft inserted into the shaft hole;
a rotor case mounted on the shaft so as to be rotatable;
a chuck housing mounted on one surface of the rotor case and including a receiving portion with an outside opening to be connected to a receiving space provided therein; and
a chuck chip comprising an elastic plate being elastically transformed when a disc being mounted on the rotor case is inserted and securing an inner circumferential surface of the disc.

10. The motor device of claim 9, wherein the elastic plate is bent such that one end thereof comes into contact with an inner surface and an upper surface of the receiving portion at the same time.

11. The motor device of claim 9, wherein a receiving recess is provided in the chuck housing such that one end of the elastic plate is inserted into the receiving recess.

12. The motor device of claim 9, wherein receiving recesses are provided in the chuck housing such that both ends of the elastic plate are inserted into the receiving recesses.

13. The motor device of claim 9, wherein the elastic plate has a protruding portion outward from the receiving portion, and wherein the protruding portion comprises an insertion portion being obliquely bent in order to insert the disc and a mounting portion being bent obliquely in an opposite direction to the insertion portion in order to mount the disc being inserted.

14. The motor device of claim 13, wherein the mounting portion is bent to have a curved cross-section.

15. The motor device of claim 9, further comprising a buffer material being bonded to an inner surface of the elastic plate.
